(19) United States
(12) Patent Application Publication
(10) Pub. No.: US 2008/0296855 A1
(43) Pub. Date: Dec. 4, 2008

(54) COLLAPSIBLE TRANSPORTATION DEVICE HAVING A BASKET WITH A MOVABLE FLOOR

(76) Inventor: Bruce ROSEMAN, White Plains, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/131,559

(22) Filed: Jun. 2, 2008

Related U.S. Application Data
(60) Provisional application No. 60/941,649, filed on Jun. 1, 2007.

(51) Int. Cl. B62D 39/00

(52) U.S. Cl. 280/33.993; 280/33.992; 280/33.994; 280/33.997

(57) ABSTRACT

The present invention provides a collapsible transportation device comprising a receptacle with a vertically movable bottom wall. The receptacle expands and collapses vertically to facilitate in loading and unloading different amounts of items in the cart, and in storing the cart when not in use. The vertical movement of the bottom wall may be controlled by a biasing assembly including multiple pairs of springs.

### CROSS REFERENCE TO RELATED APPLICATIONS

This application claims benefit under 35 U.S.C. 119(e) of U.S. Provisional Patent Application No. 60/941,649 filed on Jun. 1, 2007, the entire contents of which are herein incorporated fully by reference.

### BACKGROUND

1. Field of the Invention

This invention relates to land vehicles adapted to carry a load from one place to another, especially such land vehicles provided with supporting wheels to engage the surface over which the vehicle moves (e.g., shopping carts). This invention also relates to such land vehicles with perfecting features to facilitate the unloading of a basket (e.g., to assist in transferring items to be purchased from a shopping cart to a checkout counter). This invention also relates to such land vehicles that allow their dimensions to vary (e.g., by folding from a condition of use to a more compact or smaller non-use form for ease of storage or transport).

2. Description of the Prior Art

Shopping carts accommodate the transportation of purchased items, for example, to a vehicle or a residence. Typically, shopping carts have a basket or other receptacle for holding items to be purchased, the basket is mounted within a rigid, non-collapsible frame that has a handle and four caster-type wheels, and the either the entire basket or the rear wall thereof is adapted to pivot or articulate so that a part of a second shopping cart will at least partially interfit or be received within the boundaries of the basket to produce a nesting relation.

However, a shopping cart with a basket of fixed size can be very inconvenient. It must be large enough to hold many items, and reaching items may require the user to reach or bend down or over. Such bending movement may be painful or even difficult for certain users of a typical shopping cart. Thus, there is a need for shopping carts adapted to facilitate the retrieving of the contents therein without having a user to reach or bend down into the shopping cart basket.

The size, shape, and weight of a traditional, rigid, non-collapsible cart and its fixed basket can also be a disadvantage. When a shopping cart is used to transport items for any distance outside of a store's immediate vicinity (e.g., a few city blocks), lighter weight, smaller size, and more compact shape are obvious advantages. Moreover, traditional shopping carts are unsuitable for transport in a larger vehicle, such as a taxi or public bus. A traditional shopping cart requires a large storage space when not in use and, thusly, cannot be conveniently stored in, for example, an apartment. Thus, there is a need for a collapsible shopping cart with the above mentioned ability to facilitate the retrieving of contents therein.

### SUMMARY OF THE INVENTION

In light of the needs described above, the present invention provides a collapsible transportation device comprising a receptacle with a vertically movable bottom wall. The receptacle expands and collapses vertically to facilitate in loading and unloading different amounts of items in the cart, and in storing the cart when not in use. The vertical movement of the bottom wall may be controlled by a biasing assembly including multiple pairs of springs.

### BRIEF DESCRIPTION OF THE FIGURES

The above and other features of the inventive cart will become more readily apparent from the following detailed description of the invention in conjunction with accompanying drawings, in which:

FIGS. 1A-1C are perspective views of a shopping cart according to a preferred embodiment shown with an unloaded receptacle in an expanded position and connected to the outer frame;

FIG. 2 is a perspective view of the shopping cart of FIGS. 1A-1C with the rear pouch lifted;

FIG. 3A is a side view of the shopping cart of FIGS. 1A-1C with the receptacle collapsed;

FIG. 3B is a rear view of the shopping cart of FIGS. 1A-1C with the receptacle collapsed;

FIG. 3C is a front view of the shopping cart of FIGS. 1A-1C with the receptacle collapsed;

FIG. 4 is a perspective view of the shopping cart of FIGS. 1A-1C when collapsed;

FIG. 5 is a perspective view showing the magnetic catch of the collapsed shopping cart in FIG. 4;

FIG. 6 is a perspective view showing a brake assembly and child seat of a shopping cart according to the present invention;

FIG. 7 is a top view of the brake assembly of FIG. 6; and

FIG. 8 is a partially cross-sectioned side elevational view of the brake assembly of FIG. 6.

### DETAILED DESCRIPTION OF THE INVENTION

Reference will now be made in detail to an embodiment of the invention that is illustrated in the accompanying figures. Wherever possible, same or similar reference numerals are used in the figures and the description to refer to the same or like parts. For purposes of convenience and clarity only, directional terms, such as top, bottom, left, right, up, down, over, above, below, beneath, upper, lower, rear, and front may be used with respect to the figures. For example, as used herein, the term “moves vertically” includes movement in a direction normal to the ground and any other non-normal direction having a substantially vertical component. These and similar directional terms should not be construed to limit the scope of the invention in any manner.

A shopping cart according to the present invention comprises a wheel assembly and a load-bearing assembly, which load bearing assembly comprises an outer frame and an inner frame. The wheel assembly supports the load-bearing assembly and is adapted to engage the surface over which the shopping cart moves (e.g., with wheels). The outer frame of the load-bearing assembly is attached to the wheel assembly, and, significantly, is adapted to allow its dimensions to vary (e.g., by collapsing or folding from a condition of use to a more compact or smaller non-use form for ease of storage or transport). The inner frame of the load-bearing assembly is attached to the outer frame and, importantly, is adapted to facilitate its loading and unloading (e.g., by expanding and/or contracting).

Referring to the figures, there is shown a shopping cart according to the present invention comprising a wheel assembly that comprises a plurality of wheels and axles arranged to support and maneuver the load-bearing assembly and any load therein. The wheel assembly for the preferred embodiment shown in the drawings comprises lower rear horizontal member 13 and lower front horizontal member 15. As shown, lower rear horizontal member 13 and lower front horizontal member 15 are essentially fixed axles. Lower rear horizontal member 13 comprises two non-caster wheels 30 and lower front horizontal member 15 comprises a caster wheel 40. Although the preferred embodiment shown in the drawings comprises three wheels, two of which are non-caster wheels, the wheel assembly may, of course, comprise three, four, or more wheels, any number of which may be caster or non-caster wheels. Moreover, the wheel assembly may include a shelf extending horizontally between lower horizontal members 13, 15.

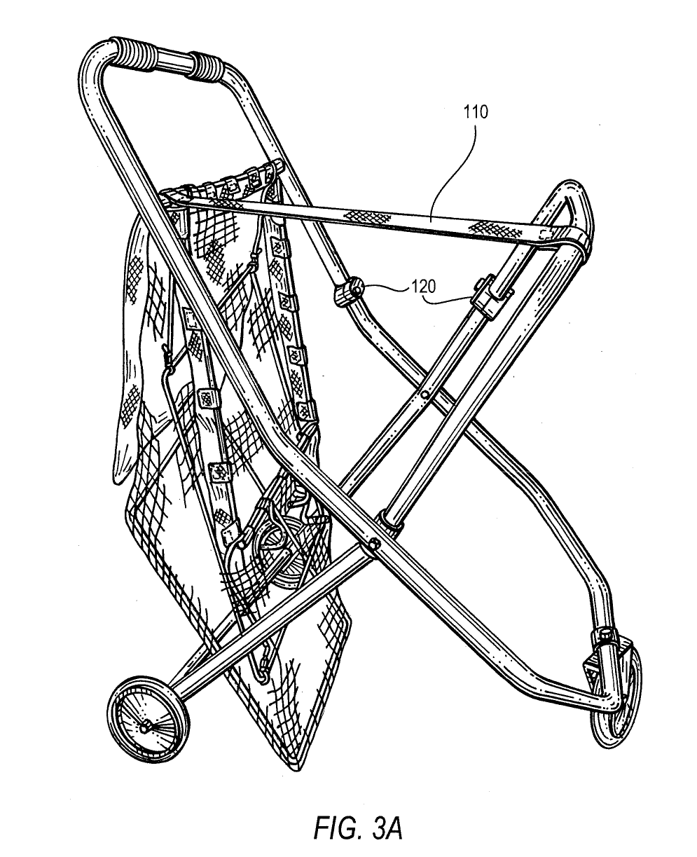

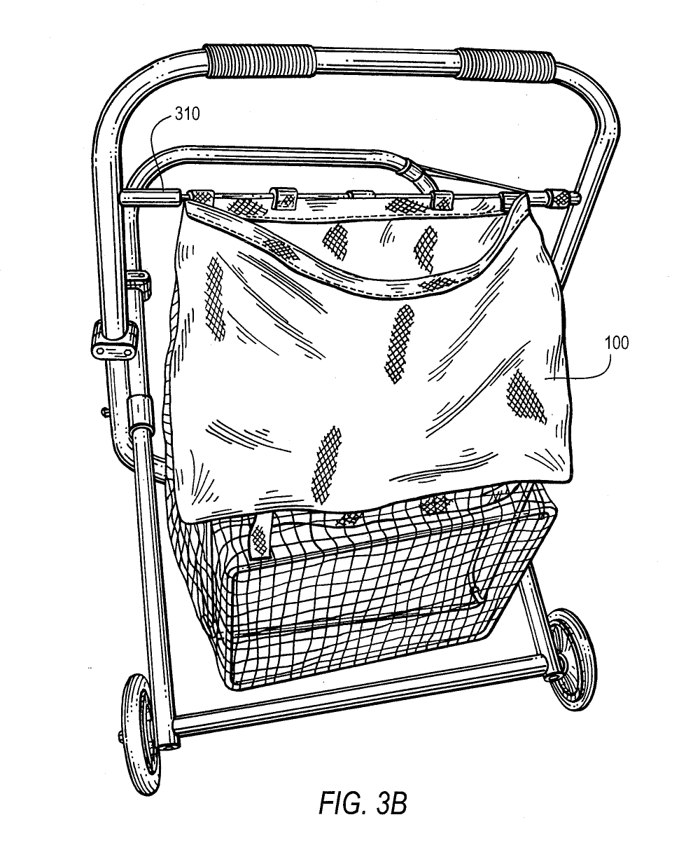

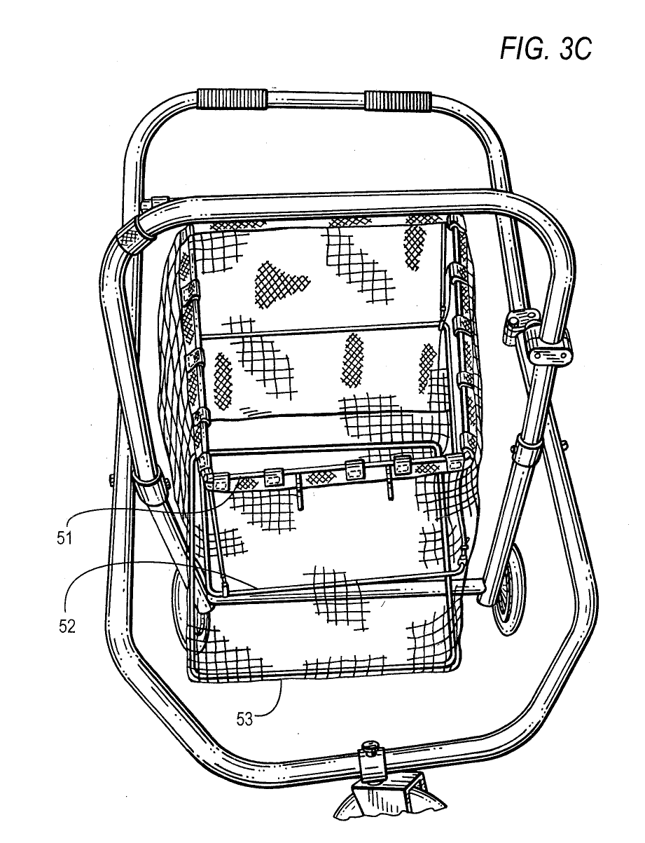

A shopping cart according to the present invention comprises a collapsible outer frame comprising vertical side members attached to the wheel assembly and adapted to collapse or fold, upper horizontal members for supporting an inner frame, and a handle. As shown, the collapsible outer frame for the preferred embodiment comprises: a pair of vertical side members 11, 12 attached to lower horizontal members 13, 15, respectively; a pair of upper horizontal members 14, 17; and a handle 16. Side member 11 is attached to upper front horizontal member 14, while side member 12 is attached to upper rear horizontal member 17. Handle 16 is attached to side member 12. A safety strap 110, as shown in FIG. 3A, is connected between upper horizontal support members 14, 17. A closure 120 comprising two parts, one on each of crossing members 11, 12, as discussed in more detail herein below, is adapted to keep the outer frame positioned in a collapsed position.

To allow collapsing or folding, side members 11, 12 may be arranged in any suitable manner (e.g., revolute joint (“pivot”), prismatic joint (“slider”), cylindrical joint, screw joint, planar joint, spherical joint (“ball and socket”)). As shown, side members 11, 12 cross each other at about their respective mid-points and that crossing point is also the location of a common pivot joint 20. The preferred pivot joint will, of course, comprise a suitable arrangement of parts (e.g., bolts, pins, screws, rivets, bushings, bearings, holes, etc.) and, for example, may be a bolt 18 that passes through juxtaposed holes in side members 11, 12.

To support an inner frame, upper horizontal members 14, 17 are preferably integrated with side members 11, 12, respectively. The dimensions of upper horizontal members 14, 17 will generally determine the maximum horizontal size the inner frame. As shown in the figures, upper front horizontal member 14 is slightly shorter than upper rear horizontal member 17 because side member 11 crosses inboard of side member 12. Therefore, rear horizontal member 17 may be provided with spacers 310 (as best seen in FIG. 3B) that will position the inner frame both centrally upon rear upper horizontal member 17 and squarely to front upper horizontal member 14.

A shopping cart according to the present invention comprises an expandable inner frame comprising an upper support member attached to the collapsible outer frame (e.g., by hooks or other suitable mechanism), flexible side walls, a bottom wall, one or more lower support members adapted to hold the flexible side walls apart and disposed below the upper support member, and expandable members adapted to lower and/or raise the bottom wall and connecting the upper support member to at least one of lower support members and/or the bottom wall. As shown, the expandable inner frame for the preferred embodiment comprises: a upper support member 51 removeably attached to upper front horizontal member 14 by hooks 60 and integrally attached to upper rear horizontal member 17; side wall netting 80; bottom wall netting 90; lower supporting members 52, 53; and expandable members 70 connecting the upper support member 51 to lower supporting member 52. Furthermore, as discussed in more detail herein below, the rear horizontal support member 17 receives or is integrated with an inner frame 50 such that the inner frame is operative to pivot about upper rear horizontal support member 17.

To form the side walls of the inner frame, the expandable inner frame is constructed with soft (e.g., fabric or non-metallic) side walls and a bottom wall supported by one or more metal support members. The advantages of a non-metallic material include the feature of eliminating the possibility of fingers or items being crushed by the collapsing sidewall because, unlike metal rods, a non-metallic sidewall will yield. As shown in the figures, the preferred inner frame of the present invention comprises side wall netting 80 attached to upper support member 51 and lower support members 52, 53.

To hold the flexible side wall netting apart, lower support members 52, 53 are preferably of the same dimensions as upper support member 51. The side wall netting 80 is securely attached to upper support member 51 so as to provide support for the netting when items are placed with the inner frame, whereas side wall netting 80 may be less rigidly attached to lower support member 52 merely to maintain the position of side wall netting 80. Lower support member 53, which is preferably the same dimensions as members 51, 52, is attached to the bottom of netting 80. The attachment of netting 80 to support member 53 is more secure than the attachment of netting 80 to support member 52 in order to provide support when items are put in the netting. A bottom wall 90 that is lightweight and firm is attached to lower support 53. Bottom wall 90 may be comprised of rigid plastic or metal mesh. Although three frames are shown in the figures, there may be any number of stages with frames vertically suspended from one to the next.

First lower support member 52 is suspended from upper support member 51 by expandable members 70, which are preferably elastomeric cords. In an alternative construction, the lower support member 52 is suspended from upper support member 51 by larger, expandable segments, such as elastomeric mesh, which may or may not be integrated with side wall 80.

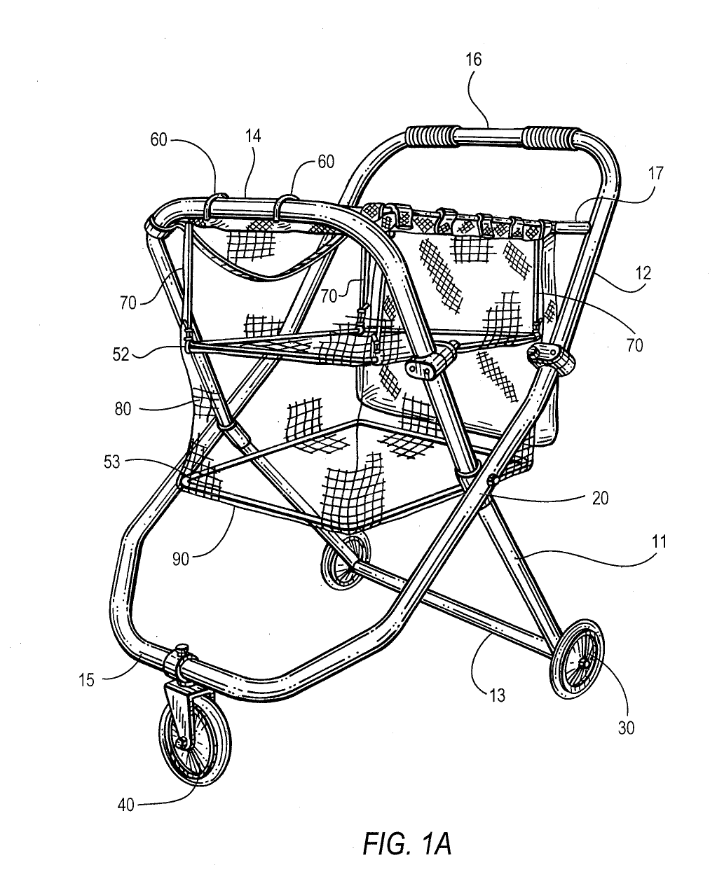

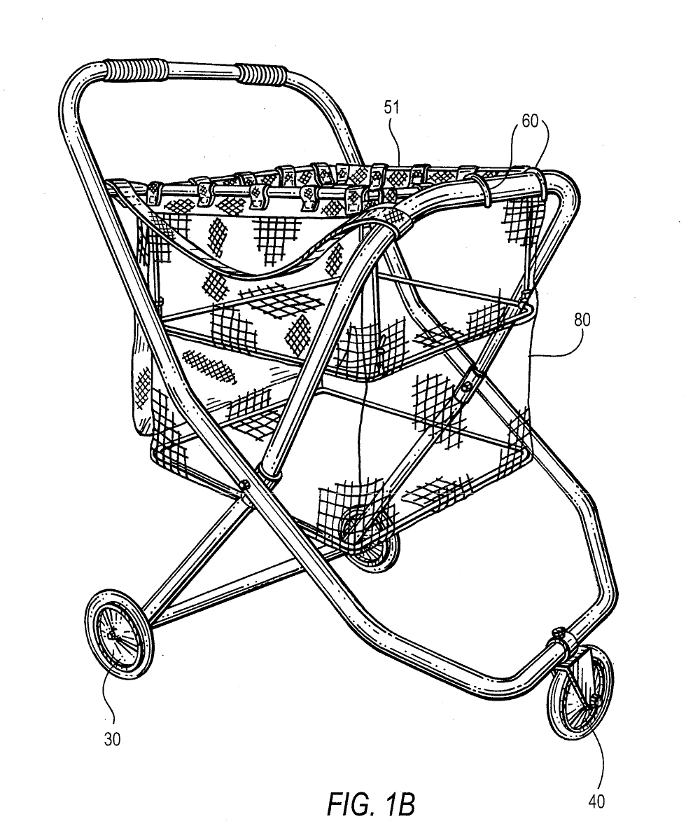

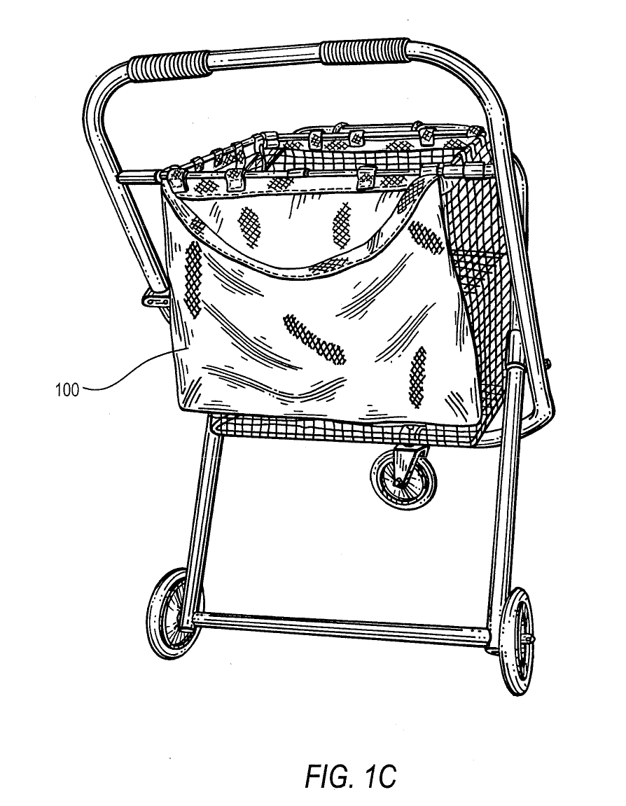

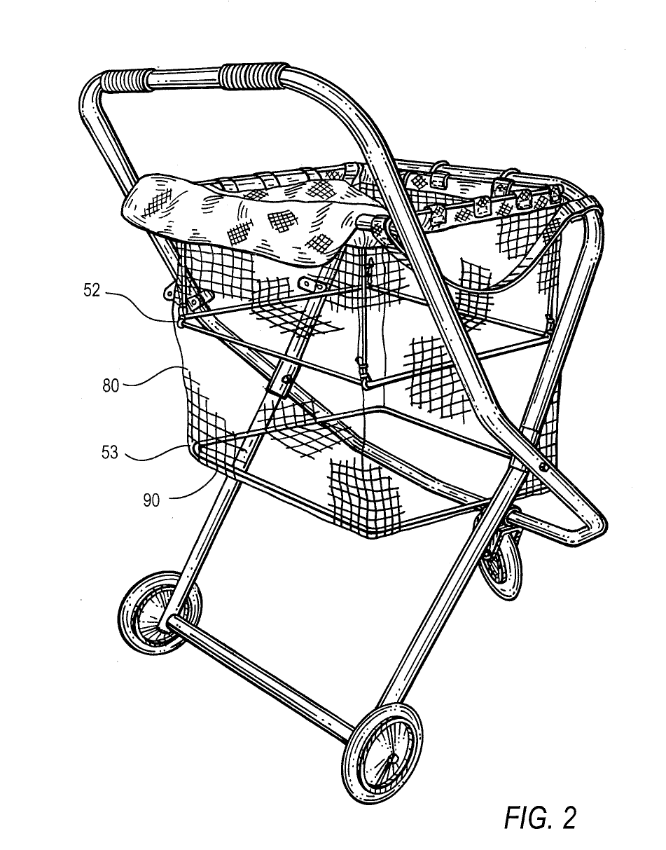

Side wall netting 80 may be tethered to at least a part of the outer frame and supplimentally supported thereby. There may also be a flexible pocket or pouch 100 attached to upper rear horizontal support member 17 and hanging outside the receptacle formed by frames 51-53 and netting 80, as best shown in FIG. 1C. The pocket or pouch 100 is attached at its upper end so it may be lifted up as shown in FIG. 2.

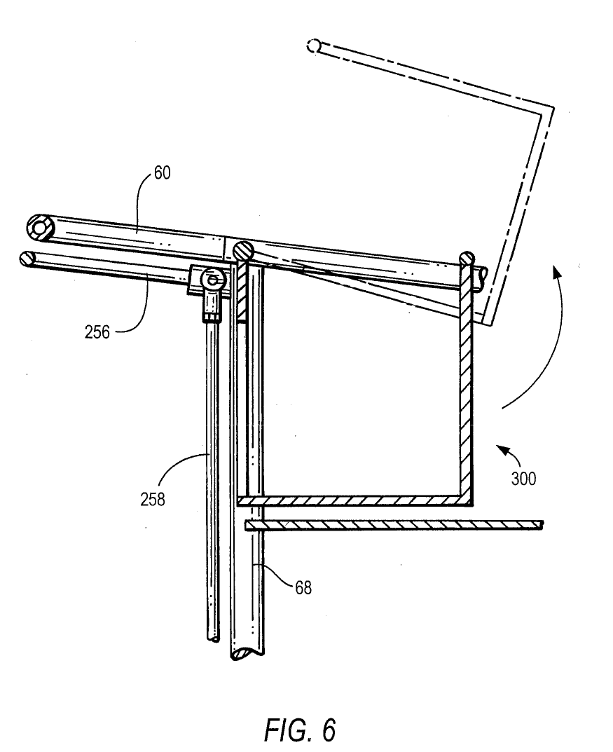

Referring to FIGS. 6, 7, and 8, since it is not unusual to see a shopping cart moving voluntarily due to uneven surfaces or an unintentional force applied to the device when it is parked or left unattended, a shopping cart according to the present invention may be provided with a brake assembly 250 configured to arrest the movement of the device when it is not in use.

An actuating component including a brake handle 256 and a transmission element is coupled under handle 16 to the outer frame. In accordance with one aspect, the transmission component has an elongated member 258, which may be, e.g., a flexible wire or rigid rod, attached between brake handle 256 and rod 259. In a rest or parking state, the cable is resiliently biased downwardly to have a pad assembly, as will be explained in reference to FIGS. 8 and 9, firmly abut a respective one of wheels. As the device user applies a squeezing force to brake handle 256, which pivots upwardly, the elongated member is tensioned or pulled and the pad assembly is lifted, thereby releasing the wheels. The break mechanism is preferably designed to default to an on/engaged position preventing unintentional cart motion.

It will be recognized by those of skill in the art that, as the break system defaults in an on position, it would be convenient to have a break disengagement system available at the front of the cart. This particular system would provide main benefit where a cart user is positioned in front of the cart and needs to pull a fully loaded cart forward. Rather than dragging the cart against the break system friction, the user may simply disengage the break system. Such a front-end disengagement system may be readily provided via a flexible cable release system (similar to element 258) with a release handle at the front (not shown)

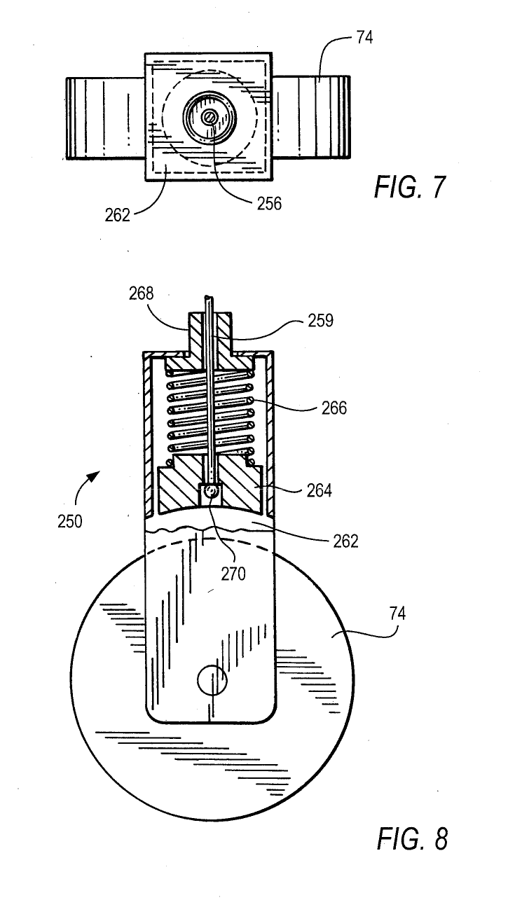

FIGS. 7 and 8 illustrate the pad assembly including a brake housing or casing 262 enveloping the lower end of rods 259, brake pad 264, which has a lower segment shaped complementary to wheel 74, resilient element 266, and inverted T-shaped bushing 268, which centers rod 259 within housing 262. In the parking state, resilient elements 266 biases the pad assembly downwardly enabling, thus the lower segment of brake pad 264 to abut the wheel. A rate of resilient elements is so selected that the device user typically does not apply a substantial force. However, the spring rate is sufficient for the resilient element to reliably press brake pad 264 against the wheel. While the upper end of rods 259 is centered by T-shaped bushings 268, the lower end of these rods is formed with an enlarged ball 270 preventing disengagement of the rods from the pad.

The pad assembly disclosed above is exemplary and can be modified. For example, instead of the springs, brake assembly 250 may be provided with a pneumatic means. Still a further alternative configuration can include a hydraulic means. Both aspects can be readily adapted by ordinary skilled workers.

As is known, shopping cards are conventionally provided with a secured or temporarily-removable child seat. As shown in FIG. 6, a preferred shopping cart according to the present invention comprises a seat 300 pivotally mounted on upper rear horizontal support member 17. When in use, seat 300 is swung into the inner frame, as shown in solid lines in FIG. 6; otherwise, seat 300 may be pivoted in a position shown in phantom lines. Pivoting to the lifted position can, of course, be performed by the device user, or by the distal end of a subsequent device that, thus, fits into the opening typically closed by the back of seat 300.

In the embodiment shown in the figures, the child seat comprises a flexible hammock supported by a bar. The bar may be moved from an open position to a closed position along slots provided at the top of the basket. The use of the flexible hammock child seat reduces the ability of a child riding in the seat to gain leverage and lift out of the seat. The child seat may optionally include a safety belt (not shown). For example, the safety belt may be generally Y shaped with two points of securement on the bar and one point of securement on the rear wall of the cart, between the child's legs. Although the child seat shown in the figures comprises a flexible hammock, any other suitable type of child seat may optionally be used.

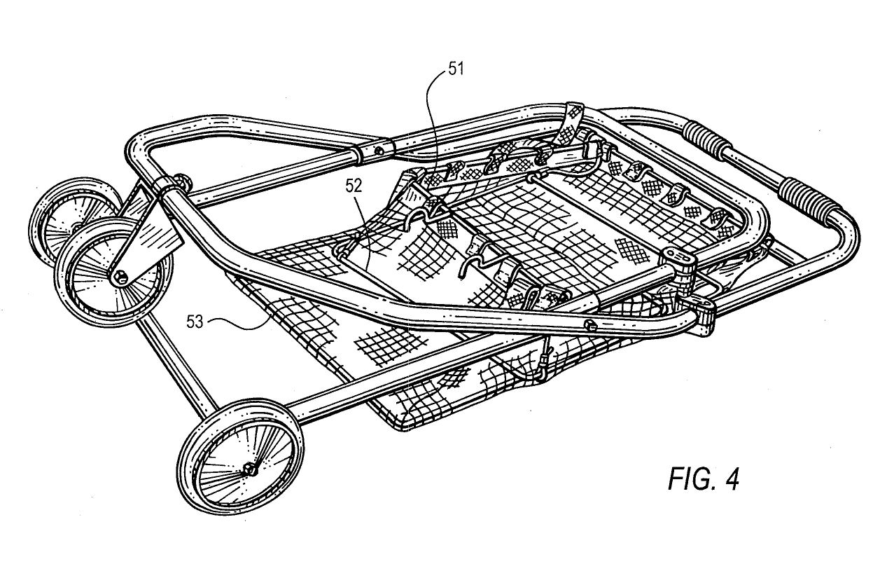

The shopping cart of the present invention can be collapsed as shown in FIGS. 3A-3C. The collapsing is done by disengaging the expandable inner frame from the collapsible outer frame, and collapsing or folding the outer frame as designed. As shown, the preferred embodiment is collapsed by: disengaging support member 51 from upper front horizontal member 14 by lifting hooks 60 from upper front horizontal support member 14; moving upper front horizontal support member 14 forward so that hooks 60 are clear there from; pivoting the now-freed inner frame about upper rear horizontal support member 17, such that the inner frame hangs down from upper rear horizontal support member 17, as shown in FIGS. 3A-3C; rotating side members 11, 12 relative to each other, such that the upper horizontal support members 14, 17 are brought substantially together and such that side members 11, 12 are substantially parallel; whereby the entire shopping cart is collapsed into a small space as shown in FIG. 4.

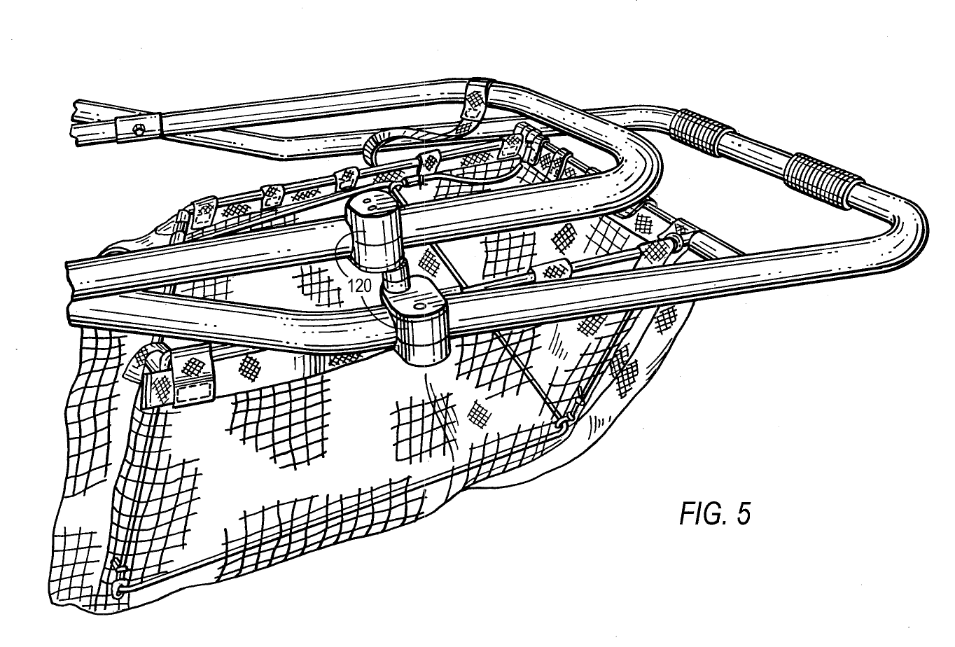

The safety strap 110, as shown in FIG. 3A, that connects the upper horizontal support members 15, 17 keep the outer frame from awkwardly flopping while the inner frame is collapsed, but the outer frame is not yet folded. The closure 120 keeps the outer frame positioned in its collapsed position. As shown, a preferred closure 120 comprises two magnets, one magnet on each of crossing members 11 and 12, as shown in FIG. 5.

A transportation device according to the present invention may be particularly suitable for commercial and/or industrial use. A commercial and/or industrial transportation device according to the present invention may be made with stronger frame members, reinforced mesh, and other similarly reinforced materials.

This application describes the inventive transportation device for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Many additional aspects are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

What is claimed is:

1. A collapsible transportation device comprising a wheel assembly and a load-bearing assembly, which load bearing assembly comprises an outer frame and an inner frame, the wheel assembly supporting the load-bearing assembly and adapted to engage the surface over which the shopping cart moves, the outer frame of the load-bearing assembly attached to the wheel assembly and adapted to allow its dimensions to vary, and the inner frame of the load-bearing assembly attached to the outer frame and adapted to facilitate its loading and unloading.

2. The collapsible transportation device of claim 1, wherein the wheel assembly comprises a plurality of wheels and axles arranged to support and maneuver the load-bearing assembly and any load therein.

3. The collapsible transportation device of claim 2, wherein the wheel assembly comprises a lower rear horizontal member and a lower front horizontal member that are fixed axles, the lower rear horizontal member comprising two non-caster wheels and lower front horizontal member comprising a caster wheel.

4. The collapsible transportation device of claim 3, wherein the wheel assembly comprises a shelf extending horizontally between the lower horizontal members.

5. The collapsible transportation device according to claim 1, wherein the collapsible outer frame comprises vertical side members attached to the wheel assembly and adapted to collapse or fold, upper horizontal members for supporting the expandable inner frame, and a handle.

6. The collapsible transportation device according to claim 5, wherein the collapsible outer frame further comprises a safety strap connected between the upper horizontal members.

7. The collapsible transportation device according to claim 5, wherein the collapsible outer framer further comprises a closure comprising two parts, one on each of crossing member, adapted to keep the outer frame positioned in a collapsed position.

8. The collapsible transportation device according to claim 5, wherein the vertical side members cross each other at about their respective mid-points and that crossing point is also the location of a common pivot joint.

9. The collapsible transportation device of claim 1, wherein the expandable inner frame comprises an upper support member attached to the collapsible outer frame, flexible side walls, a bottom wall, one or more lower support members adapted to hold the flexible side walls apart and disposed below the upper support member, and expandable members adapted to lower or raise the bottom wall and connecting the upper support member to at least one of lower support members and the bottom wall.

10. The collapsible transportation device of claim 9, wherein the expandable inner frame comprises: a upper support member removeably attached to a first portion of the outer frame and integrally attached to a second portion of the outer frame; a side wall; a bottom wall; at least one lower supporting members; and expandable members connecting the upper support member to lower to the at least one lower supporting member.

11. The collapsible transportation device of claim 10, wherein the inner frame is operative to pivot about second portion of the outer frame.

12. The collapsible transportation device of claim 10, wherein the side wall of the inner frame is constructed with soft a non-metallic material.

13. The collapsible transportation device of claim 10, wherein the side wall is securely attached to the upper support member, and the at least one lower support member is attached to the bottom wall.

14. The collapsible transportation device of claim 10, wherein the at least one lower support member is suspended from the upper support member by expandable members

15. The collapsible transportation device of claim 14, wherein the expandable members are elastomeric cords.

16. The collapsible transportation device of claim 1, further comprising a flexible pocket or pouch attached to the outer or inner frame.

17. The collapsible transportation device of claim 1, further comprising a brake assembly configured to arrest the movement of the device when it is not in use.

18. The collapsible transportation device of claim 1, further comprising a child seat.

19. A method of collapsing a collapsible transportation device according to claim 1, the method comprising the steps of disengaging the expandable inner frame from the collapsible outer frame, and collapsing or folding the outer frame.

20. A method of collapsing a collapsible transportation device according to claim 19, the method comprising the steps of disengaging a support member of the inner frame from an upper front horizontal member of the outer frame; moving the upper front horizontal support member forward so that the support member of the inner frame is clear there from; pivoting the now-freed inner frame about an upper rear horizontal support member of the outer frame, such that the inner frame hangs down from the upper rear horizontal support member; and rotating side members of the outer frame relative to each other, such that the side member are substantially parallel.
